(19) United States
(12) Patent Application Publication
(10) Pub. No.: US 2015/0271817 A1
(43) Pub. Date: Sep. 24, 2015

(54) COMMUNICATION DEVICE, WIRELESS COMMUNICATION SYSTEM, COMMUNICATION METHOD, AND COMPUTER PROGRAM PRODUCT

(71) Applicant: KABUSHIKI KAISHA TOSHIBA, Tokyo (JP)

(72) Inventors: Masaya Tarui, Yokohama (JP); Koichi Fujisaki, Kawasaki (JP); Junichi Segawa, Kawasaki (JP); Satoshi Shirai, Kawasaki (JP); Hiroyoshi Haruki, Kawasaki (JP); Yusuke Shirota, Yokohama (JP); Akihiro Shibata, Tokyo (JP); Shiyo Yoshimura, Kawasaki (JP); Tetsuro Kimura, Tokyo (JP); Tatsunori Kanai, Yokohama (JP)

(21) Appl. No.: 14/639,198

(22) Filed: Mar. 5, 2015

(30) Foreign Application Priority Data
Mar. 19, 2014 (JP) 2014-056962

(51) Int. Cl. H04W 72/04; H04L 29/08; H04W 48/08

(52) U.S. Cl. CPC H04W 72/0446; H04W 48/08; H04L 67/1046; H04L 67/1074; H04W 84/18

(57) ABSTRACT

According to an embodiment, a communication device for dynamically building a network includes a first receiver and a first transmitter. When the communication device attempts to newly join the network, the first receiver waits for reception of a first beacon containing information for joining the network from another communication device already joining the network for a predetermined first period. When the communication device is already joining the network, the first transmitter determines a schedule indicating timings at which a plurality of communication devices already joining the network transmit first beacons so that intervals at which the communication devices transmit the first beacons in the network as a whole do not exceed the first period and transmit the first beacon according to the schedule.

### CROSS-REFERENCE TO RELATED APPLICATIONS

This application is based upon and claims the benefit of priority from Japanese Patent Application No. 2014-056962, filed on Mar. 19, 2014; the entire contents of which are incorporated herein by reference.

### FIELD

Embodiments described herein relate generally to a communication device, a wireless communication system, a communication method, and a computer program product.

### BACKGROUND

In related art, for building an autonomous distributed network in a wireless communication environment, any of a plurality of communication stations belonging to a network is put into a state in which the communication station can receive a beacon from a communication station (hereinafter may be referred to as a “new communication station”) attempting to newly join the network, and the new communication station can be added to the network when the beacon from the new communication station is received by the communication station.

Furthermore, in recent years, lower power consumption is important particularly for mobile devices, and methods for reducing power used for wireless modules as much as possible have been devised. For example, a method of exchanging information indicating timings (active timings) at which communication stations that recognize each other can transmit/receive information between the communication stations to reduce power used for wireless modules when power is not required has been proposed.

In the related art, since any of a plurality of communication stations already joining a network always needs to be put in a state in which the communication station can receive a beacon from a new communication station attempting to join the network, there is a disadvantage that power consumption cannot be sufficiently reduced.

### BRIEF DESCRIPTION OF THE DRAWINGS

FIG. 1 is a diagram illustrating an example of a functional configuration of a communication station according to a first embodiment;

FIG. 2 is a chart for explaining operation of communication stations according to the first embodiment;

FIG. 3 is a chart for explaining operation of communication stations according to the first embodiment;

FIG. 4 is a diagram illustrating an example of a functional configuration of a communication station according to a second embodiment;

FIG. 5 is a chart for explaining operation of communication stations according to the second embodiment;

FIG. 6 is a chart for explaining operation of communication stations according to the second embodiment;

FIG. 7 is a chart for explaining functions of a new communication station checking function according to the second embodiment;

FIG. 8 is a chart for explaining operation of communication stations according to a modified example;

FIG. 9 is a chart for explaining operation of communication stations according to a modified example;

FIG. 10 is a diagram illustrating an example of a functional configuration of a communication station according to a modified example; and

FIG. 11 is a diagram illustrating an example of a functional configuration of a communication station according to a modified example.

### DETAILED DESCRIPTION

According to an embodiment, a communication device for dynamically building a network includes a first receiver and a first transmitter. When the communication device attempts to newly join the network, the first receiver waits for reception of a first beacon containing information for joining the network from another communication device already joining the network for a predetermined first period. When the communication device is already joining the network, the first transmitter determines a schedule indicating timings at which a plurality of communication devices already joining the network transmit first beacons so that intervals at which the communication devices transmit the first beacons in the network as a whole do not exceed the first period and transmit the first beacon according to the schedule.

Embodiments will be described in detail below with reference to the accompanying drawings.

### First Embodiment

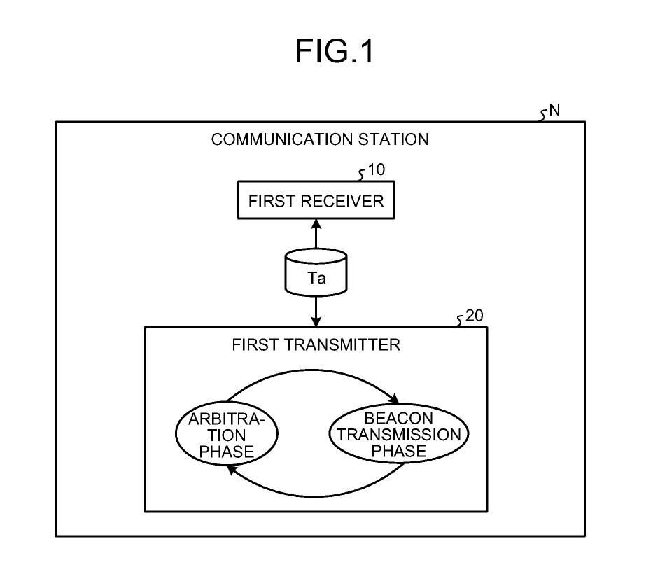

FIG. 1 is a diagram illustrating an example of a functional configuration of a communication station N for dynamically building a network. While an example of any one of a plurality of communication stations N for building a network is described herein, the same applies to the configurations of other communication stations N. In this example, the communication station N can be regarded as corresponding to a “communication device” in the claims.

The communication station N includes a first receiver 10 and a first transmitter 20. In the present embodiment, the communication station N has a hardware configuration including a CPU (central processing unit), a ROM, a RAM, a communication interface (I/F), etc. The functions of the respective components (the first receiver 10, the first transmitter 20) of the communication station N are implemented by expanding and executing programs stored in the ROM into the RAM by the CPU. Alternatively, at least some of the functions of the respective components (the first receiver 10, the first transmitter 20) of the communication station N may be implemented by dedicated hardware circuits (such as semiconductor integrated circuits)

When the communication station N attempts to newly join a network, the first receiver 10 waits for a beacon (corresponding to a “first beacon” in the claims) containing information for joining the network from another communication station N joining the network for a predetermined first period. As will be described later, in this example, a beacon transmitted by each communication station N also contains a signal (an identifier to be described later) for indicating the presence of the communication station N and thus serves as both of a “first beacon” in the claims and a “second beacon” in the claims, but the beacon is not limited thereto. For example, a first beacon containing information for joining a network and a second beacon containing a signal for indicating the presence of the communication station N may be different signals. Note that the information for joining a network is information required for allowing communication with any of communication stations N already joining the network by using predetermined procedures.

When the communication station N is already joining the network, the first transmitter 20 thereof determines a schedule indicating the timings at which the communication stations N each transmit a beacon (corresponding to the “first beacon” in the claims) so that the intervals at which the communication stations N already joining the network transmit beacons (corresponding to the “first beacon” in the claims) in the network as a whole will not exceed the first period, and transmits a beacon according to the schedule. Specifically, when the communication station N is already joining the network, the first transmitter 20 thereof determines a schedule indicating the timings at which the communication stations N already joining the network each transmit a beacon (corresponding to the “first beacon” in the claims) so that the interval between transmission of a beacon by one of the communication stations N and transmission of a beacon by another communication station N in the network as a whole will not exceed the first period, and transmits a beacon according to the schedule. More specifically, the configuration is as follows.

The first transmitter 20 has an arbitration phase representing a state of arbitrating between the communication station N and other communication stations N to determine a schedule, and a beacon transmission phase representing a state of sending (transmitting) a beacon of the communication station N according to the determined schedule. For determining a schedule, the first transmitter 20 transmits a beacon (corresponding to the “second beacon” in the claims) containing a signal for indicating the presence of the communication station N on the basis of the information for joining the network (in this example, information indicating a timing of a next arbitration phase as will be described later), and the first receiver 10 receives beacons (corresponding to the “second beacon” in the claims) from other communication stations N and determines the schedule on the basis of the signal (a signal for indicating the presence of the communication station N) contained in the beacon of the communication station N and the beacon of another communication station N. In this example, the first transmitter 20 of each of all the communication stations N already joining the network transmits a beacon to other communication stations N within a predetermined time period (1 second, for example) in the arbitration phase. Each of the communication stations N receives beacons from the other communication stations, and determines a schedule on the basis of the beacon of the communication station N and the beacons from the other communication stations N. In this example, a beacon contains an identifier representing a number for identifying the communication station N that transmits the beacon. In this example, the identifier corresponds to the signal for indicating the presence of the communication station N. The first transmitter 20 of each communication station N determines an order in which the identifier contained in the beacon (corresponding to the “second beacon” in the claims) of the communication station N and the identifiers contained in the beacons (corresponding to the “second beacons” in the claims) of the other communication stations N are arranged according to a predetermined rule to be the order in which the communication stations N transmit beacons (corresponding to the “first beacons” in the claims). Subsequently, the transmission phase is entered, and the first transmitter 20 of each communication station N transmits the beacon of the communication station N according to the schedule determined in the arbitration phase.

In this example, in the transmission phase, a beacon is transmitted according to the schedule each time the time period Ta (four seconds in this example, but not limited thereto) corresponding to the first period elapses, and the arbitration phase is entered again at the time point when a predetermined time period (three seconds in this example, but not limited thereto) has elapsed from the time point when transmission of beacons from all the communication stations N was completed.

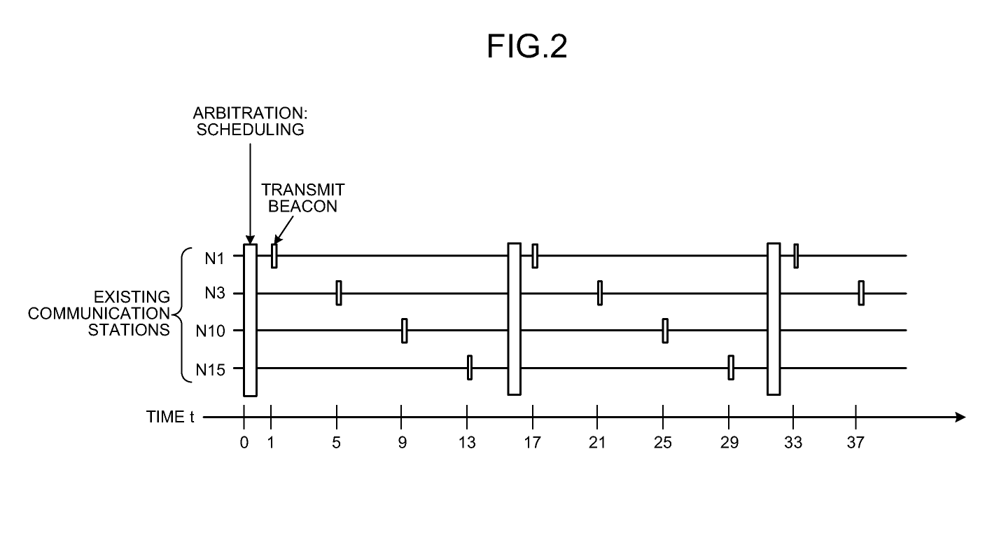

In this example, a communication station N identified by an identifier represented by “x” will be represented by “Nx”. For example, as illustrated in FIG. 2, assume a case in which a communication station N1 identified by an identifier represented by “1”, a communication station N3 identified by an identifier represented by “3”, a communication station N10 identified by an identifier represented by “10”, and a communication station N15 identified by an identifier represented by “15” build one network, which are in the arbitration phase at time 0.

When attention is focused on the communication station N3, in the arbitration phase, the first transmitter 20 of the communication station N3 transmits a beacon of the communication station N3, and the first receiver 10 of the communication station N3 receives beacons from the other communication stations N1, N10, and N15. The first transmitter 20 of the communication station N3 determines the order (in this example, the order in ascending order of the numbers) in which the identifier (the identifier represented by “3”) contained in the beacon of the communication station N3 and the identifiers contained in the beacons of the other communication stations N1, N10, and N15 are arranged according to a predetermined rule to be the order in which the communication stations N transmit beacons. In this example, the first transmitter 20 of the communication station N3 determines the communication station N3 to be the second communication station to transmit its beacon. Furthermore, since the first transmitter 20 of the communication station N3 can detect that there are three other communication stations N (N1, N10 and N15) already joining the network, the first transmitter 20 deems that four communication stations N including the communication station N3 build up the network and determines the next arbitration phase to take place 4 seconds×4=16 seconds later. Similarly, the first transmitters 20 of the other communication stations N can determine the order in which the beacons of the communication stations N are transmitted and the timing of the next arbitration phase.

In this example, a beacon transmitted by each communication station N also contains information for joining the network in addition to the identifier of the communication station N, but the beacon is not limited thereto. If the time period from transmission of a beacon from a certain communication station N until transmission of a beacon from a next communication station N is determined in advance, the timing of the next arbitration phase can be derived from the beacon of the communication station N and the beacons received from the other communication stations N. Thus, a beacon containing information for joining the network may be a beacon itself serving as information for joining the network. Herein, the information indicating the timing of the next arbitration phase can be regarded as corresponding to the “information for joining the network”. Alternatively, the configuration may be such that communication with the communication stations N already joining the network is allowed as a result of transmitting a beacon within n second from immediately after receiving a beacon, and participation in the network is allowed as a result of the communication.

In the example of FIG. 2, in the arbitration phase at time 0, the first transmitter 20 of each communication station N determines the order of transmitting beacons to be the communication station N1→the communication station N3→the communication station N10→the communication station N15, and determines the timing of the next arbitration phase to be time 16 that is 16 seconds after time 0. The transmission phase is then entered, the first transmitter 20 of the communication station N1 sends a beacon at time 1, the first transmitter 20 of the communication station N3 sends a beacon at time 5 that is four seconds after time 1, the first transmitter 20 of the communication station N10 sends a beacon at time 9 that is four seconds after time 5, and the first transmitter 20 of the communication station N15 sends a beacon at time 13 that is four seconds after time 9.

The first transmitter 20 of each communication station N enters the arbitration phase again at time 16 that is three seconds after time 13 when transmission of beacons from all the communication stations N (N1, N3, N10, and N15) is completed, and determines the order of transmitting beacons to be the communication station N1→the communication station N3→the communication station N10→the communication station N15 similarly to the arbitration phase at time 0, and determines the timing of the next arbitration phase to be time 32 that is 16 seconds after time 16. The transmission phase is then entered, the first transmitter 20 of the communication station N1 sends a beacon at time 17, the first transmitter 20 of the communication station N3 sends a beacon at time 21 that is four seconds after time 17, the first transmitter 20 of the communication station N10 sends a beacon at time 25 that is four seconds after time 21,and the first transmitter 20 of the communication station N15 sends a beacon at time 29 that is four seconds after time 25.

The first transmitter 20 of each communication station N enters the arbitration phase again at time 32 that is three seconds after time 29 when transmission of beacons from all the communication stations N (N1, N3, N10, and N15) is completed, and determines the order of transmitting beacons to be the communication station N1→the communication station N3→the communication station N10→the communication station N15 similarly to the arbitration phases at time 0 and time 16, and determines the timing of the next arbitration phase to be time 48 that is 16 seconds after time 32. In this manner, beacons of the communication stations N are transmitted at intervals of four seconds (in four-second periods).

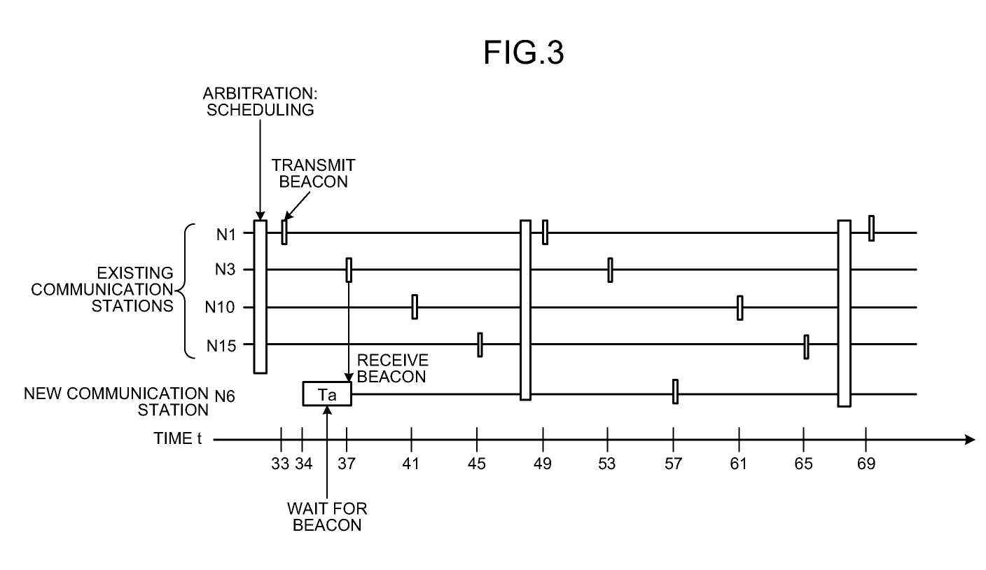

Here, as illustrated in FIG. 3, assume a case in which a process for a new communication station N6 to join the network (the network built by the communication station N1, the communication station N3, the communication station N10, and the communication station N15) is started at time 34. As described above, when a communication station N attempts to newly join a network, the first receiver 10 thereof waits for reception of a beacon from another communication station N already joining the network for the time period Ta corresponding to the predetermined first period (four seconds in this example). The first receiver 10 of the communication station N6 thus waits for a beacon for four seconds from time 34 to time 38. Since the communication station N3 transmits a beacon at time 37, the first receiver 10 of the communication station N6 can receive the beacon and join the network. The beacon also contains information indicating the timing of the next arbitration phase (information indicating that the timing of the next arbitration phase is time 48) and the communication station N6 will thus enter the arbitration phase at time 48 that is the timing of the next arbitration phase.

Furthermore, when a communication station N disconnects from the network, the communication station N preferably sends its beacon before disconnection. This can ensure transmission of beacons from the communication stations N at four-second intervals.

According to the above, if each of the communication stations N puts a communication module for carrying out radio communication into a state capable of transmitting a beacon only twice during 20 seconds from time 48 to immediately before time 68, for example, it is possible to ensure that a communication station attempting to newly join the network only needs to wait for a beacon for four seconds to join the network and to reduce power consumption of the communication modules of the communication stations N already joining the network. Furthermore, if a beacon is not received within four seconds, the communication station N attempting to newly join the network can confirm the absence of the network and thus need not further consume power at the communication module for waiting for a beacon.

Furthermore, according to the present embodiment, it is not necessary to always put any one of a plurality of communication stations N building a network into a state capable of receiving a beacon from a communication station N attempting to newly join the network but it is only necessary to intermittently put the communication module of each communication station N into a state capable of transmitting a beacon, which can achieve an advantageous effect that power consumption can be sufficiently reduced as compared to the configuration of the related art.

### Second Embodiment

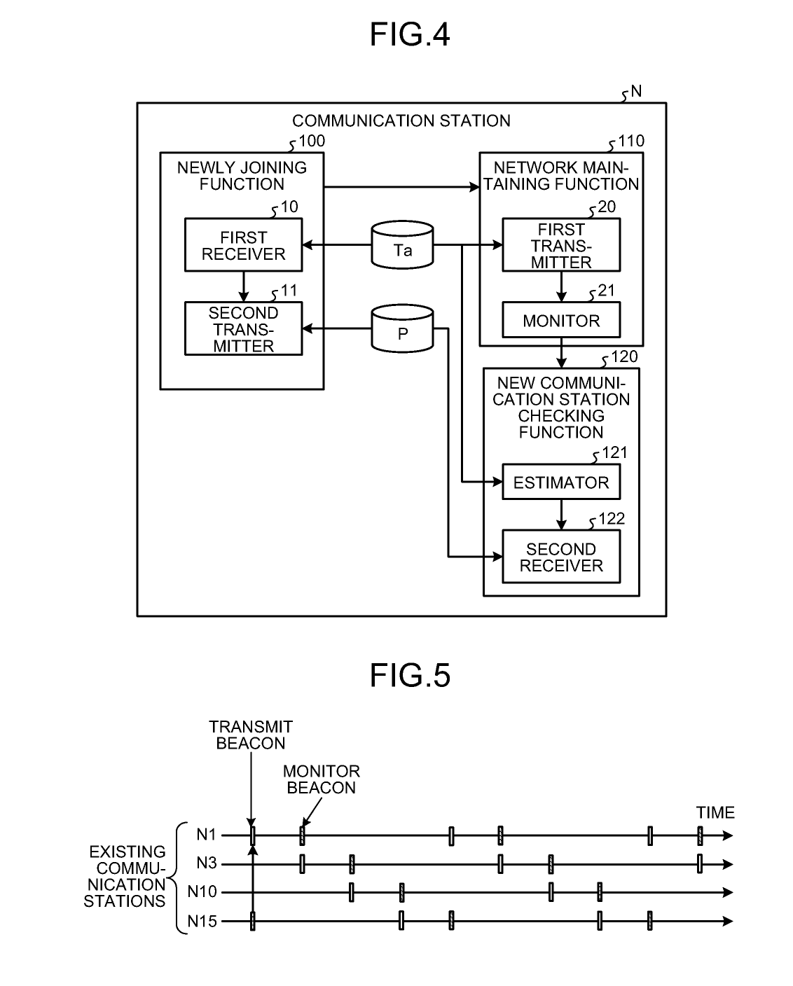

Next, a second embodiment will be described. Description of parts that are the same as those in the first embodiment described above will not be repeated as appropriate. FIG. 4 is a diagram illustrating an example of a functional configuration of a communication station N according to the second embodiment. As illustrated in FIG. 4, the communication station N of the second embodiment includes a newly joining function 100, a network maintaining function 110, and a new communication station checking function 120.

The newly joining function 100 is a function for newly joining a network, and includes a first receiver 10 and a second transmitter 11. As described above, when the communication station N attempts to newly join a network, the first receiver 10 thereof waits for a beacon (corresponding to the “first beacon” in the claims) from another communication station N joining the network for the predetermined first period. If the first receiver 10 receives a beacon within the first period, the communication station N joins the network and enters a network maintenance mode to maintain the network.

If the first receiver 10 receives no beacon within the first period, the second transmitter 11 transmits a beacon (corresponding to a “third beacon” in the claims) of the communication station N in a predetermined pattern P. This beacon is a beacon containing information for another communication station N to communicate with the communication station N. Since the communication station N has not joined the network yet, this beacon does not contain information for joining the network. In this example, in the pattern P, the communication station N transmits the beacon each time the time period Ta (four seconds in this example) corresponding to the first period elapses. Note that the pattern P is not limited to defining of a constant period, but may be a pattern using a pseudorandom number sequence, for example. When a response to the beacon transmitted in the pattern P is returned, the communication station N can join the network with the signal of the response and the state of the communication station N enters the network maintenance mode.

The network maintaining function 110 is a function for maintaining the network, and includes the first transmitter 20 and a monitor 21. The functions of the first transmitter 20 are the same as those in the first embodiment described above. When the communication station N is already joining the network, the monitor 21 monitors whether or not another communication station N to be monitored transmit a beacon according to the schedule determined in the arbitration phase. In this example, the communication stations N to be monitored by each of a plurality of communication stations N building the network are determined in advance, but the communication stations N to be monitored are not limited thereto and may be determined through arbitration similarly to scheduling of the timings at which beacons are to be transmitted, for example. In the example of FIG. 5, the communication station to be monitored by the communication station N1 is the communication station N3, and the communication station N1 monitors a beacon from the communication station N3. In addition, the communication station to be monitored by the communication station N3 is the communication station N10, and the communication station N3 monitors a beacon from the communication station N10. Furthermore, the communication station to be monitored by the communication station N10 is the communication station N15, and the communication station N10 monitors a beacon from the communication station N15. Furthermore, the communication station to be monitored by the communication station N15 is the communication station N1, and the communication station N15 monitors a beacon from the communication station N1.

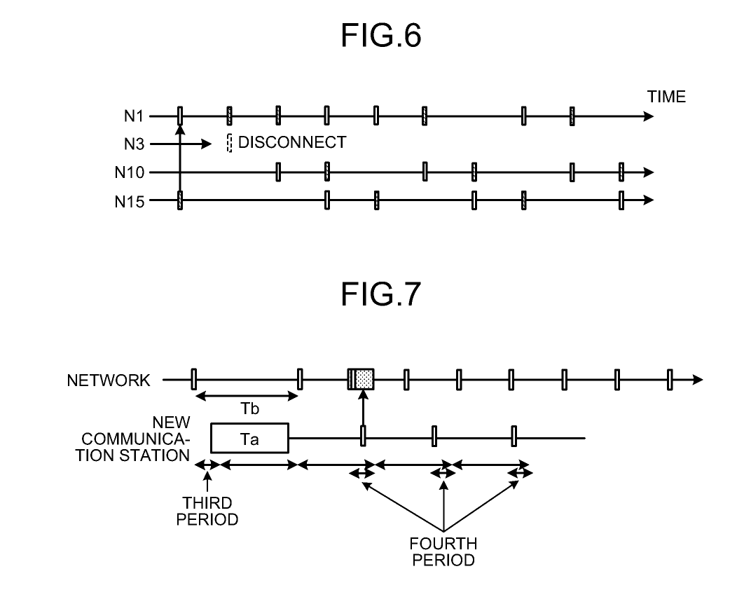

In the present embodiment, if the communication station N to be monitored does not transmit a beacon according to the schedule, the monitor 21 also has a function of monitoring whether or not a communication station N to be monitored by the communication station N to be monitored transmits a beacon according to the schedule. As illustrated in FIG. 6, for example, when the communication station N3 to be monitored by the communication station N1 disconnects from the network without transmitting a beacon, the monitor 21 of the communication station N1 cannot confirm a beacon from the communication station N3 at the timing when the communication station N3 should send a beacon (at the scheduled timing) and therefore determines that the communication station N3 has disconnected from the network. The communication station N1 then monitors whether or not the communication station N10 to be monitored by the communication station N3 that has disconnected from the network transmits a beacon according to the schedule.

The description is continued referring back to FIG. 4. When a beacon to be monitored cannot be confirmed, the monitor 21 passes information indicating the schedule determined in the arbitration phase and information indicating the beacon that could not be confirmed to the new communication station checking function 120.

The new communication station checking function 120 is a function for checking the presence of a communication station attempting to newly join the network, and includes an estimator 121 and a second receiver 122. If no beacon is transmitted for a second period longer than the first period described above as a result of monitoring by the monitor 21, the estimator 121 assumes that a new communication station N waiting for a beacon (corresponding to the “first beacon” in the claims) to join the network is present in the second period and estimates a third period representing a time period during which the new communication station N may have started to wait for a beacon.

In FIG. 6, for example, as a result of disconnection of the communication station N3, no beacon is transmitted for eight seconds from transmission of a beacon by the communication station N1 until transmission of a beacon by the communication station N10. As described above, since the time period corresponding to the first period is four seconds, no beacon is transmitted for the second period (may be referred to as the “second period Tb” in the description below) longer than the first period (may be referred to as the “first period Ta” in the description below) in the example of FIG. 6.

The estimator 121 estimates the second period Tb on the basis of information indicating the schedule and information indicating a beacon that could not be confirmed from the monitor 21. The estimator 121 then estimates the third period representing the time period during which the new communication station N started to wait for a beacon on the basis of the estimated second period Tb and the predetermined first period Ta. As illustrated in FIG. 7, the estimator 121 can estimate a time period from the start of the second period Tb to immediately before the lapse of (Tb−Ta) therefrom as the third period.

The description is continued referring back to FIG. 4. The second receiver 122 estimates a fourth period representing a time period during which the new communication station N may transmit a beacon (corresponding to the “third beacon” in the claims) on the basis of the pattern P described above and the third period, and waits for reception of a beacon from the new communication station N in the estimated fourth period. As described above, in this example, since the pattern P described above is a pattern in which a beacon of the communication station N is transmitted each time a time period (four seconds in this example) corresponding to the first period Ta elapses, the second receiver 122 can estimate a time point (in this example, a time point that is eight seconds from the start of the third period) after a lapse of the time period (four seconds) corresponding to the first period Ta from the start of the estimated third period and further a lapse of the time period (four seconds) corresponding to the first period Ta as the start of the fourth period appearing for the first time in the example of FIG. 7. The estimator 121 can also estimate a time point (in this example, a time point that is eight seconds from the end of the third period) after a lapse of the time period (four seconds) corresponding to the first period Ta from the end of the estimated third period and further a lapse of the time period (four seconds) corresponding to the first period Ta as the end of the fourth period appearing for the first time. In this manner, the estimator 121 can estimate the fourth period appearing for the first time. The estimator 121 can estimate the fourth periods appearing for the second and subsequent times in the same manner. The second receiver 122 can then check the presence of a new communication station N by waiting for reception of a beacon from the new communication station N in the fourth period estimated as described above.

### Modified Example 1 of Second Embodiment

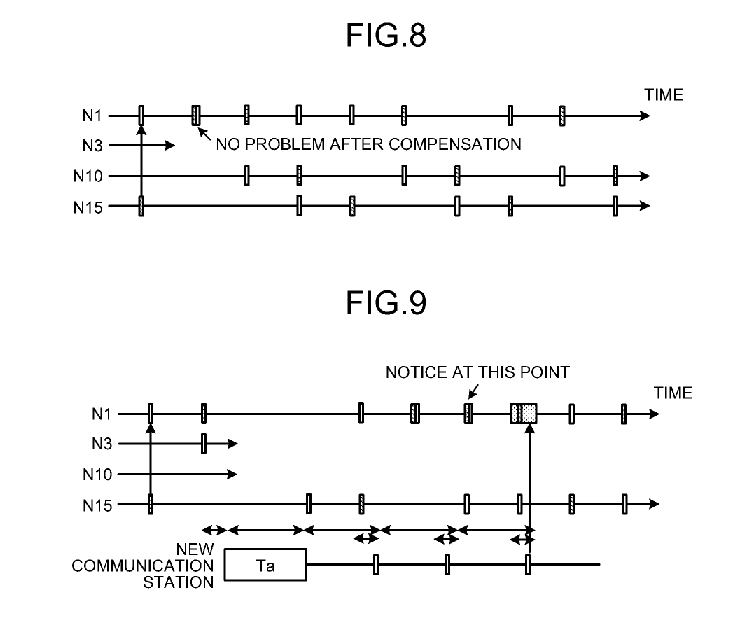

For example, when it is confirmed that the communication station N to be monitored does not transmit a beacon according to the schedule, each of the communication stations N building the network can transmit a beacon in place of the communication station N to be monitored. As illustrated in FIG. 8, for example, if the monitor 21 of the communication station N1 cannot confirm a beacon from the communication station N3 to be monitored, the first transmitter 20 of the communication station N1 can transmit a beacon for the communication station N3.

As illustrated in FIG. 9, however, if the communication station N3 disconnected from the network immediately after transmitting a beacon and the communication station N10 to be monitored by the communication station N3 disconnected from the network at the same time without transmitting a beacon, the communication station N1 notices that no beacon has been transmitted for the second period Tb longer than the first period Ta since the communication station N3 transmitted a beacon only at the time point when no beacon from the communication station N10 to be monitored by the communication station N3 can be confirmed. In such a case, similarly to the second embodiment described above, the monitor 21 of the communication station N1 passes the information indicating the schedule and the information indicating the beacon that could not be confirmed (information indicating the beacon of the communication station N10 in the example of FIG. 9) to the new communication station checking function 120, the estimator 121 of the new communication station checking function 120 estimates the third period representing the time period during which a new communication station N may started to wait for a beacon, and the second receiver 122 of the new communication station checking function 120 estimates the fourth period on the basis of the pattern P described above and the third period and can check the presence of the new communication station N by waiting for a beacon from the new communication station N for the estimated fourth period.

### Modified Example 2 of Second Embodiment

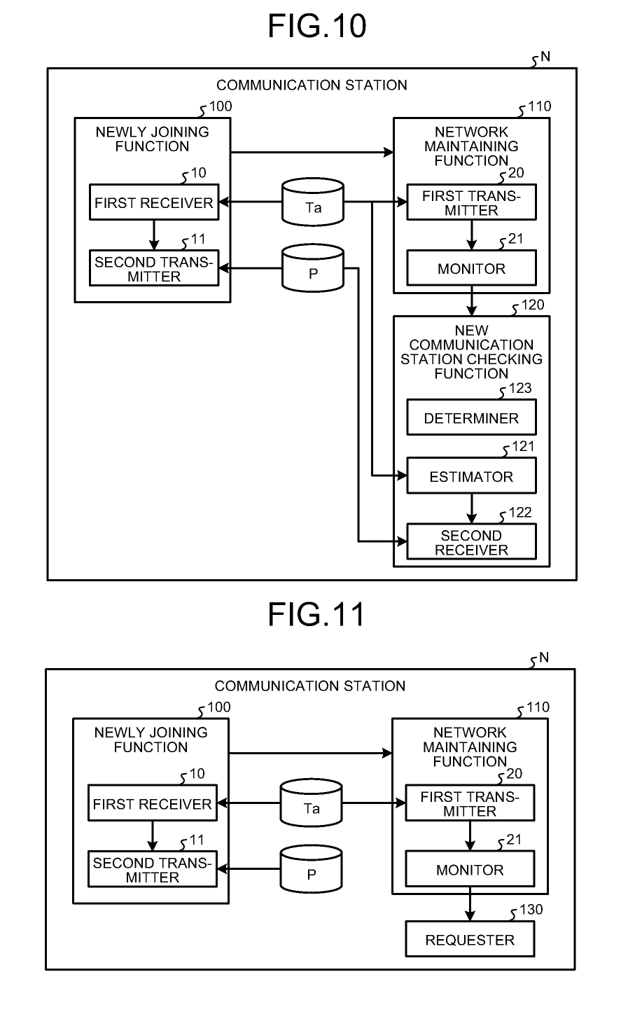

As illustrated in FIG. 10, for example, the new communication station checking function 120 may further include a determiner 123. If no beacon is transmitted for the second period Tb longer than the first period Ta as a result of monitoring by the monitor 21, the determiner 123 has a function of determining the communication station N that checks the presence of a new communication station N with other communication stations N already joining the network (more specifically, estimating the third period and the fourth period described above and determining the communication station N that waits for reception of a beacon from a new communication station N during the estimated fourth period).

### Modified Example 3 of Second Embodiment

As illustrated in FIG. 11, for example, each of the communication stations N may include a requester 130 instead of the new communication station checking function 120 described above. If no beacon is transmitted for the second period Tb longer than the first period Ta described above as a result of monitoring by the monitor 21, the requester 130 requests a device in another network to check the presence of a new communication station N waiting for a beacon to newly join the network during the second period Tb. According to such a configuration, since the communication stations N need not include the new communication station checking functions 120 described above, the configuration of each communication station N can be made simpler and the processing load can be reduced. As a result, further power reduction can be achieved.

The embodiments described above can be combined as appropriate. Moreover, although the arbitration phase for carrying out arbitration in a determined time for scheduling is provided in the embodiments, etc. described above, the embodiments are not limited thereto.

Programs to be executed by the communication stations N described above may be stored on a computer system connected to a network such as the Internet, and provided by being downloaded via the network. Alternatively, the programs to be executed by the communication stations N described above may be provided or distributed through a network such as the Internet. Still alternatively, the programs to be executed by the communication stations N described above may be embedded on a nonvolatile storage medium such as a ROM in advance and provided therefrom.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device for dynamically building a network, the communication device comprising:
a first receiver configured to, when the communication device attempts to newly join the network, wait for reception of a first beacon containing information for joining the network from another communication device already joining the network for a predetermined first period; and
a first transmitter configured to, when the communication device is already joining the network, determine a schedule indicating timings at which a plurality of communication devices already joining the network transmit first beacons so that intervals at which the plurality of communication devices transmit the first beacons in the network as a whole do not exceed the first period and transmit the first beacon according to the schedule.

2. The device according to claim 1, wherein
for determining the schedule,
the first transmitter transmits a second beacon containing a signal for indicating presence of the communication device on the basis of the information for joining the network,
the first receiver receives second beacons from the other communication devices, and
the first transmitter determines the schedule on the basis of the signal contained in the second beacon of the communication device and the second beacons from the other communication devices.

3. The device according to claim 2, wherein
the second beacon contains at least an identifier that is a number for identifying its corresponding communication device, and
the first transmitter determines an order in which the identifier contained in the second beacon of the communication device and identifiers contained in the second beacons of the other communication devices are arranged according to a predetermined rule to be an order in which the first beacons are to be transmitted from the communication devices.

4. The device according to claim 2, wherein the second beacon is the first beacon.

5. The device according to claim 3, wherein the second beacon is the first beacon.

6. The device according to claim 1, further comprising a second transmitter configured to transmit a third beacon containing information for carrying out communication with the communication device in a predetermined pattern when the first receiver has not received the first beacon within the first period.

7. The device according to claim 6, further comprising:
a monitor configured to, when the communication device is already joining the network, monitor whether or not another communication device to be monitored transmits the first beacon according to the schedule;
an estimator configured to, when the first beacon has not been transmitted for a second period longer than the first period as a result of the monitoring by the monitor, assume that a new communication device that is another communication device waiting for reception of the first beacon to newly join the network in the second period is present, and estimate a third period that is a time period during which the new communication device may have started to wait for the first beacon; and
a second receiver configured to estimate a fourth period that is a time period during which the new communication device may have transmitted the third beacon on the basis of the pattern and the third period, and wait for reception of the third beacon from the new communication device during the estimated fourth period.

8. The device according to claim 5, further comprising:
a monitor configured to, when the communication device is already joining the network, monitor whether or not another communication device to be monitored transmits the first beacon according to the schedule; and
a determiner configured to determine a communication device that checks presence of the new communication device with the other communication devices already joining the network when the first beacon has not been transmitted for a second period longer than the first period as a result of the monitoring by the monitor.

9. The device according to claim 6, further comprising:
a monitor configured to, when the communication device is already joining the network, monitor whether or not another communication device to be monitored transmits the first beacon according to the schedule; and
a requester configured to, when the first beacon has not be transmitted for the second period as a result of the monitoring by the monitor, request another device to check presence of a new communication device that is another communication device waiting for the first beacon in order to newly join the network in a second period longer than the first period.

10. The device according to claim 7, wherein when the other communication device to be monitored has not transmitted the first beacon according to the schedule, the monitor monitors whether or not a communication device to be monitored by the other communication device to be monitored transmits the first beacon according to the schedule.

11. The device according to claim 9, wherein when the other communication device to be monitored has not transmitted the first beacon according to the schedule, the monitor monitors whether or not a communication device to be monitored by the other communication device to be monitored transmits the first beacon according to the schedule.

12. A wireless communication system comprising a plurality of communication devices for dynamically building a network, wherein each of the communication devices includes:
a first receiver configured to, when the communication device attempts to newly join the network, wait for reception of a beacon containing information for joining the network from another communication device already joining the network for a predetermined first period; and
a first transmitter configured to, when the communication device is already joining the network, determine a schedule indicating timings at which the communication devices already joining the network transmit beacons so that intervals at which the communication devices transmit the beacons in the network as a whole do not exceed the first period and transmit the beacon according to the determined schedule.

13. A communication method to be carried out by a communication device for dynamically building a network, the communication method comprising:
waiting, when the communication device attempts to newly join the network, for reception of a beacon containing information for joining the network from another communication device already joining the network for a predetermined first period; and
determining, when the communication device is already joining the network, a schedule indicating timings at which a plurality of communication devices already joining the network transmit beacons so that intervals at which the communication devices transmit the beacons in the network as a whole do not exceed the first period and transmitting the beacon according to the determined schedule.

14. A computer program product comprising a computer readable medium including programmed instructions, wherein the instructions, when executed by a communication device for dynamically building a network, cause the communication device to function as:
a first receiver configured to, when the communication device attempts to newly join the network, wait for reception of a first beacon containing information for joining the network from another communication device already joining the network for a predetermined first period; and
a first transmitter configured to, when the communication device is already joining the network, determine a schedule indicating timings at which a plurality of communication devices already joining the network transmit first beacons so that intervals at which the communication devices transmit the first beacons in the network as a whole do not exceed the first period and transmit the first beacon according to the schedule.
